(19) United States
(12) Patent Application Publication
(10) Pub. No.: US 2019/0194991 A1
(43) Pub. Date: Jun. 27, 2019

(54) SLIDING DOOR AND WINDOW ROLLER ASSEMBLY

(71) Applicant: GOLDBRECHT INC., Culver City, CA (US)

(72) Inventors: Marcel FONTIJN, Culver City, CA (US); Thomas KERN, Culver City, CA (US)

(73) Assignee: Goldbrecht Inc., Culver City, CA (US)

(21) Appl. No.: 15/759,607

(22) PCT Filed: Sep. 14, 2017
(86) PCT No.: PCT/US2017/051565

§ 371 Date: Mar. 13, 2018

Related U.S. Application Data
(60) Provisional application No. 62/395,014, filed on Sep. 15, 2016.

(51) Int. Cl. E05D 15/06; E06B 3/46

(52) U.S. Cl. CPC E05D 15/0665; E06B 3/46; E05Y 2201/684; E05Y 2800/244; E05Y 2800/21; E05Y 2800/23; E05Y 2201/69

(57) ABSTRACT

A sliding roller assembly includes a plurality of blocks, configured to be connected in series, at least one roller device provided between each of the plurality of blocks, where the roller device includes a main body having at least one roller bearing disposed in the main body.

### CROSS-REFERENCES TO RELATED APPLICATIONS

This application is based on and claims priority from U.S. Provisional Application No. 62/395,014 filed on Sep. 15, 2016, the entire contents of which are incorporated herein by reference.

### BACKGROUND

### 1. Field

Exemplary embodiments relate to sliding doors and windows, and more particularly, to an assembly allowing automatic and manual adjustments of roller mechanisms to compensate for construction tolerances and building movement.

### 2. Description of the Related Art

Conventional methods and apparatuses for installing doors and windows fix the outer frame to the building, and the inner frame or sash of the door or window slides along the outer frame.

Conventional methods of installing doors and windows, however, do not compensate for installation tolerances, building movement, or settlement of the building.

Exemplary embodiments overcome these shortcomings associated with the prior methods and apparatuses for installing doors and windows. The exemplary embodiments provide a unique pivoting mechanism to combine automatic and manual adjustment methods to compensate for these construction tolerances/building movements.

### SUMMARY OF THE INVENTION

One or more exemplary embodiments include a sliding roller assembly. Additional aspects will be set forth in part in the description which follows and, in part, will be apparent from the description, or may be learned by practice of the exemplary embodiments.

According to another exemplary embodiment, a sliding roller assembly, including a plurality of blocks, configured to be connected in series, at least one roller device provided between each of the plurality of blocks, where the roller device includes a main body having at least one roller bearing disposed in the main body.

According to another exemplary embodiment, the plurality of blocks are fixed to a door frame or a window frame.

According to another exemplary embodiment, the body further includes at least one through hole, and a shaft provided in the through hole which extends into a hole in a body of at least one of the plurality of blocks.

According to another exemplary embodiment, a sleeve is provided on an end of the shaft and at least part of the sleeve is disposed in the hole.

According to another exemplary embodiment, the sliding roller assembly further includes a moving member that contacts the at least one roller bearing and slides with respect to the plurality of blocks and the at least one roller bearing.

According to another exemplary embodiment, a thickness of at least one of the plurality of blocks is greater than a thickness of the at least one roller device.

In accordance with one aspect of an exemplary embodiment, a sliding roller assembly includes a body, at least one cavity extending into the body from a first side of the roller device at least one roller bearing disposed within the at least one cavity, secured in the cavity by a roller bearing shaft; and at least one hole on a second side of the roller device, perpendicular to the first side, and configured to receive a shaft.

According to another exemplary embodiment, the at least one hole extends through the body of the roller device.

According to another exemplary embodiment, a sleeve is provided on at least one end of the shaft.

According to another exemplary embodiment, the at least one roller bearing is angled away from a center of the body.

According to another exemplary embodiment, the at least one roller bearing is angled toward a center of the body.

In accordance with one aspect of an exemplary embodiment, a sliding assembly is configured to move a door or window and includes a frame, a sliding mechanism disposed within the frame, and a moving member configured to contact the sliding member and move along the sliding member to move a window or a door.

According to another exemplary embodiment, the sliding mechanism includes a plurality of blocks and a roller device, provided between and connected to each of the plurality of blocks, including at least one bearing, such that the moving member is configured to slide along the at least one bearing.

According to another exemplary embodiment, the roller device is connected to the plurality of blocks by a shaft provided in a through hole in the roller device.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is an exploded perspective view of a sliding roller assembly according to exemplary embodiment;

FIG. 2 is an exploded perspective view of a sliding roller assembly according to another exemplary embodiment;

FIG. 3 is a view of a roller device of a sliding roller assembly according to an exemplary embodiment;

FIG. 4 is a view of a roller device of a sliding roller assembly according to another exemplary embodiment;

FIG. 5 is a view of a roller device of a sliding roller assembly according to another exemplary embodiment which includes a thermal break;

FIG. 6 is a perspective view of a roller device of a sliding roller assembly according to an exemplary embodiment; and

FIG. 7 is a perspective view of a roller device of a sliding roller assembly according to another exemplary embodiment.

### DETAILED DESCRIPTION

Exemplary embodiments may allow various changes or modifications, including various changes in form, and specific exemplary embodiments will be illustrated in drawings and described in detail in the specification. However, it should be understood that the specific exemplary embodiments do not limit the present inventive concept to a specific disclosing form but include every modified, equivalent, or replaced one within the spirit and technical scope of the present inventive concept. In the following description, well-known functions or constructions are not described in detail since they would obscure the invention with unnecessary detail.

The terminology used in the application is used only to describe specific exemplary embodiments and does not have any intention to limit the present inventive concept. Although general terms as currently widely used as possible are selected as the terms used in the present inventive concept while taking functions in the exemplary embodiments into account, they may vary according to an intention of those of ordinary skill in the art, judicial precedents, or the appearance of new technology. In addition, in specific cases, terms intentionally selected by the applicant may be used, and in this case, the meaning of the terms will be disclosed in corresponding description of the invention. Accordingly, the terms used in the present inventive concept should be defined not by simple names of the terms but by the meaning of the terms and the content over the present inventive concept.

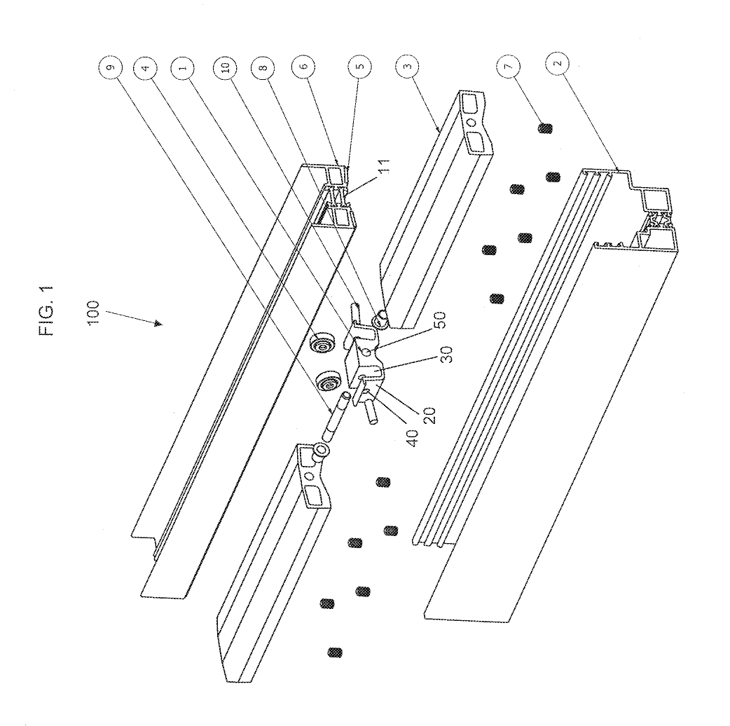

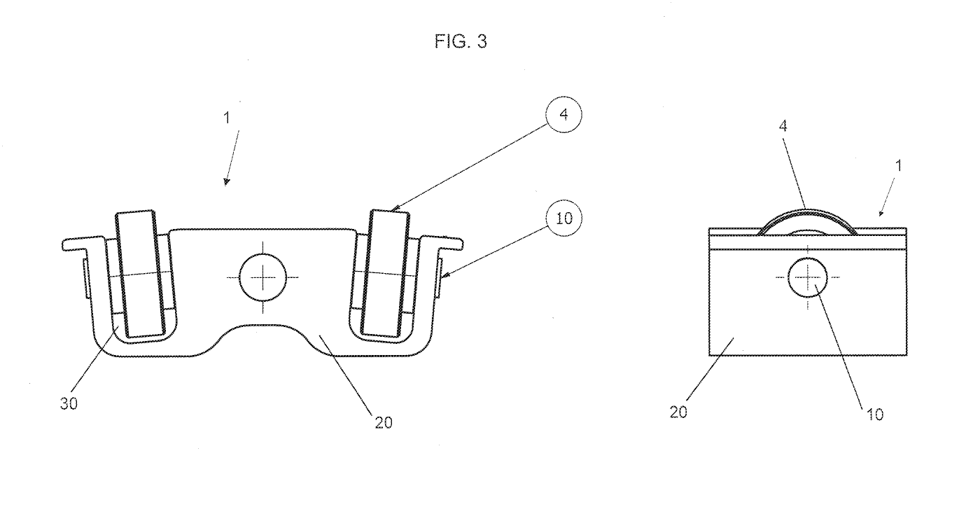

As shown in the drawings, with reference made to the reference numerals in FIG. 1, the sliding roller assembly 100 according to an exemplary embodiment includes a plurality of blocks 3 connected in series and at least one roller device 1 provided between and interconnecting adjacent blocks 3 such that the sliding roller assembly 100 extends in a longitudinal direction. The sliding roller assembly 100 further includes a moving member 6 which may contact and move along the roller device 1. As shown in FIG. 3, the roller device 1 includes a main body 20 having at least one cavity 30 extending therein from a first side of the roller device. At least one roller bearing 4 is disposed within the cavity 30, and secured in the cavity by a bearing shaft 10 supported at each end by the main body 20. Further, it will be understood that the roller bearing 4 may be secured to an outer side of the roller device 1. The roller bearing 4 may be angled toward an outside or an inside of the roller device 1 or may be perpendicular to a bottom of the roller device 1.

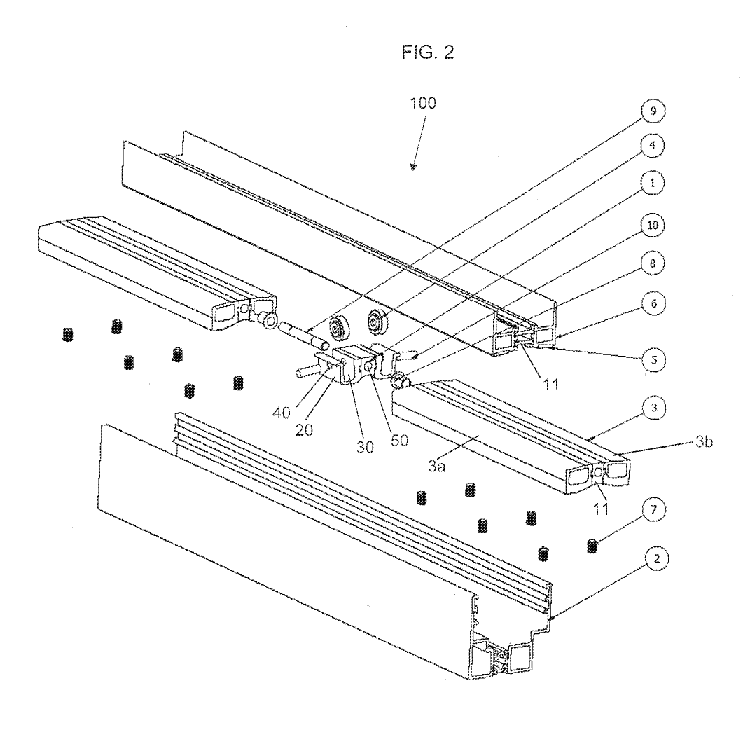

The main body also has at least one through hole 50 extending from a second side of the main body to an opposite third side, both being perpendicular to the first side. The through hole 50 is configured to receive a shaft 9 having end portions extending from the opposing second and third sides of the main body and extending in the longitudinal direction, as shown in FIGS. 1 and 2.

FIGS. 1 and 2 illustrate a sleeve 8 provided on each exposed end portion of the shaft 9. One of the sleeves 8 is received in a hole 50 provided in the longitudinal end face of one of the blocks 3 and the opposing sleeve 8 is received in the end hole 50 of the longitudinal end face of another block 3 such that the roller device 1 interconnects the adjacent blocks 3. The end portions of the shafts 9 are rotatably held in the sleeves 8 such that the roller device 1 can rotate around the axis of the shaft 9 and with respect to the plurality of blocks 3. Thus, the sleeves 8 allow for improved swiveling movement of the main body 20 with respect to the blocks. However, it will be understood that the sleeve 8 is but one exemplary embodiment, and the swiveling movement can be effected without the use of the sleeve 8. For example, it will be understood by those skilled in the art that the swiveling may be achieved using only a washer on a shaft or by inserting the shaft 9 into the hole 50 without a washer or a sleeve 8.

The plurality of blocks 3 and associated roller device may be disposed within a bottom of a door frame or a window frame 2, as shown in FIGS. 1 and 2. However, it will be understood that the plurality of blocks 3 can be attached to a top portion of a door frame or a window frame, as well. A set of screws or various leveling devices 7 can be screwed or set beneath the plurality of blocks 3 to fix or align the plurality of blocks 3 to the door or window frame 2. This ensures that the entire sliding roller assembly 100 is perfectly level across each individual portion of the sliding roller assembly 100. One or more of the plurality of blocks 3 can be removed from the door frame or window frame 2 and the screws or leveling devices 7 can be adjusted to ensure that the sliding door is level, which is important in high-tolerance sliding door and window systems. Further, each roller device 1 can be individually leveled to adjust the height of the roller device 1 with respect to the plurality of blocks 3. In addition, the plurality of blocks 3 may include other features known to one of ordinary skill in the art.

In one embodiment, the thickness of the roller device 1 in a direction perpendicular to or parallel to a moving direction of the moving member 6 is less than the thickness of the plurality of blocks 3. However, it will be understood that the thickness of the roller devices 1 and the blocks 3 can vary. Further, the dimensions of the roller device 1 and the plurality of blocks 3, including but not limited to the height and width, can vary depending on the requirements of the door or window frame.

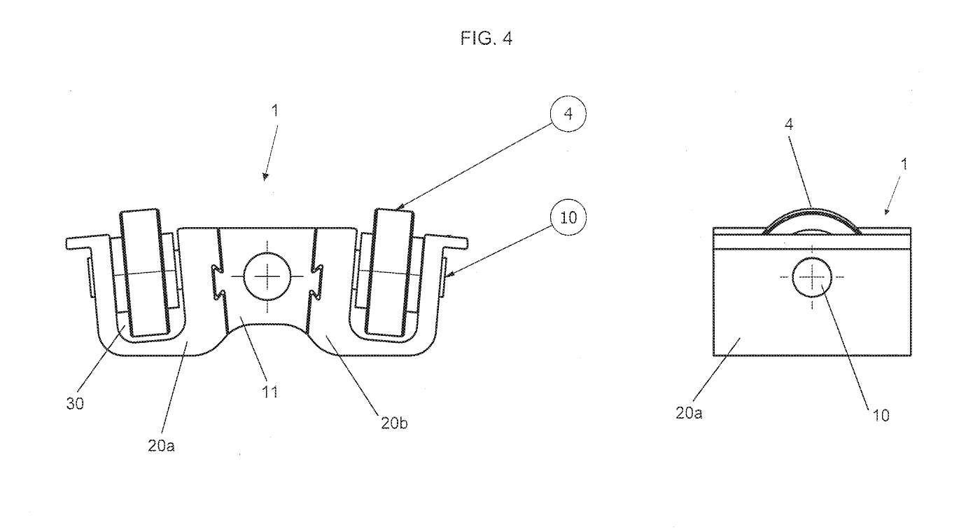

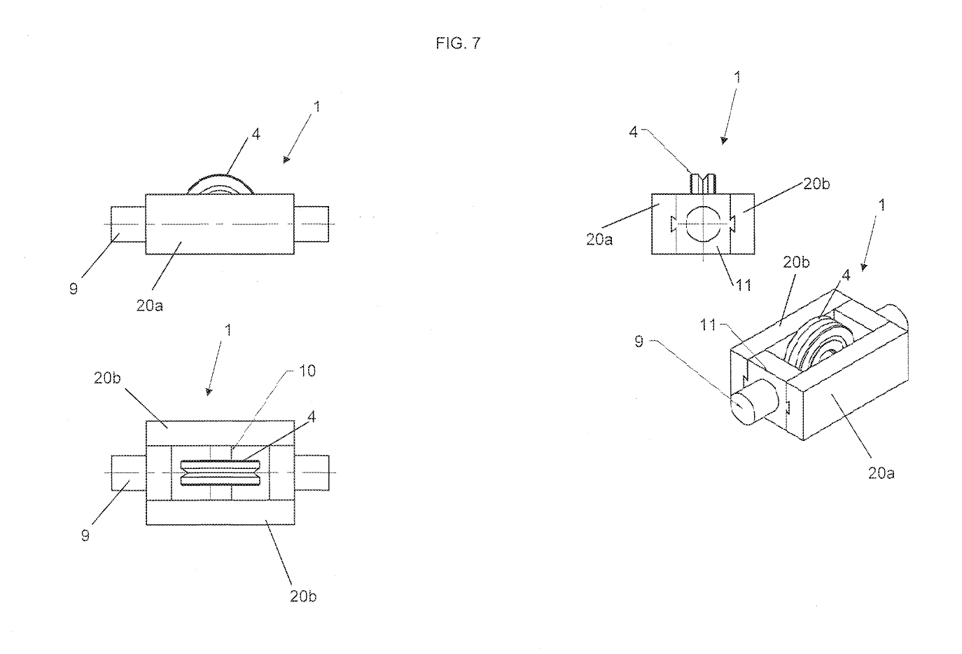

Further, it will be understood that the sliding roller assembly 100 and/or the blocks 3 may include a thermal break 11 formed from a thermally separating material to reduce the thermal conductivity of the assembly. For example, as shown in FIGS. 4 and 7, the sides 20a, 20b of a roller device 1 can be connected by the thermal break 11, which can reduce the thermal conductivity of the assembly. FIG. 2 similarly illustrates a thermal break 11 connecting the two side portions 3a, 3b blocks 3.

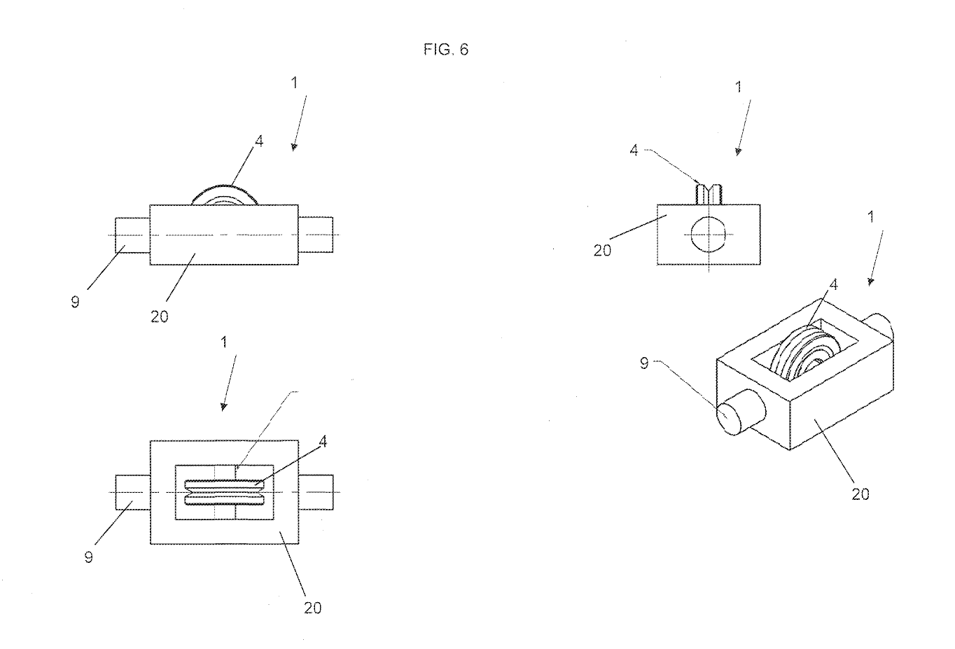

As shown in FIGS. 6 and 7, in an alternative embodiment the roller device 1 may include a single bearing 4 located centrally between the side 20a and 20b. A thermal break 11 is similarly provided between two side portions 20a, 20b of the roller device 1 as shown.

As shown in FIG. 1, the sliding roller assembly 100 further includes the moving member 6, which contacts the roller bearing 4 and slides with respect to the plurality of blocks 3 and the roller device 1. The moving member 6 supports the glass of a door or window such that the door or window can be easily opened or closed by a sliding movement of the moving member 6 on the sliding roller assembly 100. The moving member may also include a strip 5 on a bottom portion thereof which aids in reducing the friction between the moving member 6 and the roller bearing 4 during movement. The strip 5 can made of brass or any other material known in the art that can reduce friction. According to one exemplary embodiment, the moving member 6 may also include a thermal break 11.

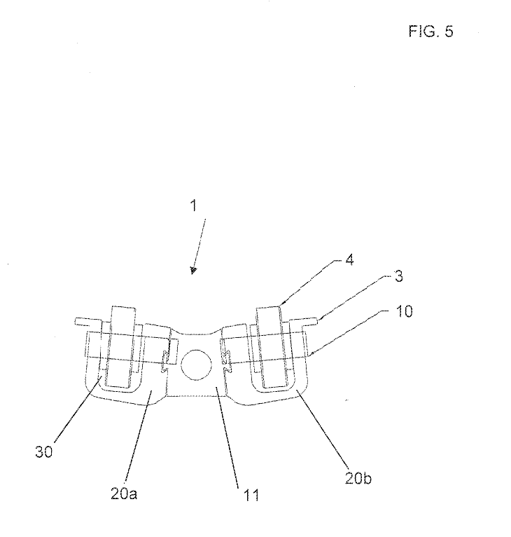

FIGS. 5 and 6 illustrate that the roller bearings 4 can be angled either toward a center of the roller device 1 or away from a center of the roller device 1. This allows the moving member 6 to slide smoothly, even if the building in which the sliding roller assembly 100 is installed has moved or due to installation tolerances.

Further, the assembly provides for adjustability in multiple dimensions. For example, the roller device 1 can be moved axially along the shaft 9 closer to or further from the blocks 3. The roller device 1 is also capable of rotating about the axis of the shaft 9 as discussed above. The roller bearings 4 are also capable of moving laterally along the bearing shaft 10 within the groove of the body. Thus, the shafts 9, sleeves 8, and roller bearings 4 may be configured to permit relative movement of the blocks 3 with respect to the roller device 1 in at least three directions. That is, the roller device 1 may move in three degrees of freedom laterally with respect to the blocks 3, rotationally with respect to the blocks 3 and axially with respect to the shaft 9.

The above-described sliding roller assembly allows the moving member 6 of a window or door to slide smooth within the frame or sash. Since the roller bearings 4 and the shaft-and-sleeve 9, 8 assembly allow the roller device 1 to move on three axes, the sliding roller assembly 100 compensates for any misalignments due to installation tolerances, building movements, and/or settlement of the building and thereby avoid significant impact on the force required to move sliding panels.

While the exemplary embodiments have been particularly shown and described, it will be understood by those of ordinary skill in the art that various changes in form and details may be made therein without departing from the spirit and scope of the inventive concept as defined by the appended claims.

What is claimed is:

1. A sliding roller assembly, comprising:
a plurality of blocks, configured to be connected in series;
at least one roller device provided between and connected to each of the plurality of blocks, wherein
the roller device includes a main body having at least one roller bearing disposed in the main body.

2. The sliding roller assembly of claim 1, wherein the plurality of blocks are fixed to or placed in a door frame or a window frame.

3. The sliding roller assembly of claim 1, wherein the main body further includes at least one through hole, and
a shaft provided in the through hole which extends into a hole in a body of at least one of the plurality of blocks.

4. The sliding roller assembly of claim 3, wherein a sleeve is provided on an end of the shaft and at least part of the sleeve is disposed in the hole.

5. The sliding roller assembly of claim 3, wherein a washer is provided on the shaft.

6. The sliding roller assembly of claim 1, further comprising:
a moving member that contacts the at least one roller bearing and slides with respect to the plurality of blocks and the at least one roller bearing and supports a window or a door provided on the moving member.

7. The sliding roller assembly of claim 1, wherein a thickness of at least one of the plurality of blocks is greater than a thickness of the at least one roller device.

8. A roller device, comprising:
a main body;
at least one cavity extending into the main body from a first side of the roller device;
at least one roller bearing disposed within the at least one cavity, secured in the cavity by a roller bearing shaft; and
at least one hole on a second side of the roller device, perpendicular to the first side,
and configured to receive a shaft.

9. The roller device of claim 8, wherein the at least one hole extends through the main body of the roller device.

10. The roller device of claim 8, wherein a sleeve or a washer is provided on at least one end of the shaft.

11. The sliding roller assembly of claim 8, wherein the at least one roller bearing is angled away from a center of the main body.

12. The sliding roller assembly of claim 8, wherein the at least one roller bearing is angled toward a center of the main body.

13. A sliding roller assembly configured to move a door or window, comprising:
a frame;
a sliding mechanism disposed within the frame; and
a moving member configured to contact the sliding member and move along the sliding member to move a window or a door.

14. The sliding roller assembly of claim 13, wherein the sliding mechanism comprises:
a plurality of blocks; and
a roller device, provided between and connected to each of the plurality of blocks, including at least one bearing,
wherein the moving member is configured to slide along the at least one bearing.

15. The sliding roller assembly of claim 14, wherein the roller device is connected to the plurality of blocks by a shaft provided in a through hole in the roller device.
